(19) United States
(12) Patent Application Publication
(10) Pub. No.: US 2016/0204419 A1
(43) Pub. Date: Jul. 14, 2016

(54) Vanadium Solid-Salt Battery and Vanadium Solid Salt Composite

(71) Applicants: Brother Kogyo Kabushiki Kaisha, Nagoya-shi (JP); Tohoku Techno Arch Co., Ltd., Sendai-shi (JP)

(72) Inventors: Shigeki Yoshida, Toyoake-shi (JP); Tomoo Yamamura, Sendai-shi (JP); Norihiko Tanno, Nagoya-shi (JP); Satoshi Mitani, Nagoya-shi (JP)

(21) Appl. No.: 15/073,880

(22) Filed: Mar. 18, 2016

Related U.S. Application Data
(63) Continuation of application No. PCT/JP2014/075031, filed on Sep. 22, 2014.

(30) Foreign Application Priority Data
Sep. 30, 2013 (JP) 2013-205757

(51) Int. Cl. H01M 4/36; H01M 4/62; H01M 4/58

(52) U.S. Cl. CPC H01M 4/364; H01M 4/5825; H01M 4/625

(57) ABSTRACT

A vanadium solid-salt battery includes: a positive electrode and a negative electrode each of which includes vanadium solid salt, the vanadium solid salt containing an electrolyte, a carbon material, and vanadium ion and/or cation including vanadium, wherein the carbon material is carbon powder of which R value obtained by Raman spectroscopy is not more than 1.10 or of which interplanar spacing d (d002) measured by X-ray powder diffraction is in a range of 0.33 nm to 0.36 nm; and a content amount of the carbon material in the vanadium solid salt is in a range of 1% by mass to 42% by mass.

### CROSS REFERENCE TO RELATED APPLICATION

This application is a Continuation Application of International Application No. PCT/JP2014/075031 which was filed on Sep. 22, 2014 claiming the conventional priority of Japanese patent Application No. 2013-205757 filed on Sep. 30, 2013.

### BACKGROUND OF THE INVENTION

1. Field of the Invention

The present disclosure relates to a vanadium battery using electrolyte containing vanadium as an active material. In particular, the present disclosure relates to a vanadium solid-salt battery (hereinafter referred to as “VSSB (Vanadium Solid-Salt Battery)”) containing a solid vanadium salt in the positive and negative electrode thereof.

2. Description of the Related Art

A secondary battery (rechargeable battery) is widely used not only for digital home electrical appliances but also for motor-powered electric automobiles and hybrid automobiles. As such a rechargeable battery, a vanadium solid-salt battery is proposed (PCT International Publication No. WO2011/049103). The vanadium solid-salt battery disclosed in PCT International Publication No. WO2011/049103 is provided with positive and negative electrodes each including an electrode material such as carbon felt and a deposited substance which contains vanadium ion or cation including vanadium and which is supported on the electrode material.

The vanadium solid-salt battery disclosed in PCT International Publication No. WO2011/049103 is required to have a further improved battery performance. Here, the term “battery performance” is exemplified to include the capacity maintenance rate, coulombic efficiency and energy efficiency. Conventionally, electrolyte circulation-type redox-flow batteries have been studied and researched to as to enhance the battery performance thereof. However, regarding the vanadium solid-salt battery, the battery performance has not been sufficiently improved.

An object of the present disclosure is to provide a vanadium solid-salt battery with improved capacity maintenance rate, coulombic efficiency and energy efficiency.

### SUMMARY OF THE INVENTION

According to a first aspect of the present disclosure, there is provided a vanadium solid-salt battery including:

a positive electrode and a negative electrode each of which includes vanadium solid salt, the vanadium solid salt containing an electrolyte, a carbon material, and vanadium ion and/or cation including vanadium,

wherein the carbon material is carbon powder of which R value obtained by Raman spectroscopy is not more than 1.10 or of which interplanar spacing d (d002) measured by X-ray powder diffraction is in a range of 0.33 nm to 0.36 nm; and

a content amount of the carbon material in the vanadium solid salt is in a range of 1% by mass to 42% by mass.

According to a second aspect of the present disclosure, there is provided a vanadium solid salt composite for forming vanadium solid salt for positive electrode of a vanadium solid-salt battery, the vanadium solid salt composite for positive electrode including:

vanadium oxide sulfate (IV);

an electrolyte; and

a carbon powder of which R value obtained by Raman spectroscopy is not more than 1.10 and of which interplanar spacing d (d002) measured by X-ray powder diffraction is in a range of 0.33 nm to 0.36 nm;

wherein a content amount of the vanadium oxide sulfate (IV) in the vanadium solid salt composite is in a range of 57.0% by mass to 85.0% by mass.

According to a third aspect of the present disclosure, there is provided a vanadium solid salt composite for forming vanadium solid salt for negative electrode of a vanadium solid-salt battery, the vanadium solid salt composite for negative electrode including:

vanadium sulfate (III);

an electrolyte; and

a carbon powder of which R value obtained by Raman spectroscopy is not more than 1.10 and of which interplanar spacing d (d002) measured by X-ray powder diffraction is in a range of 0.33 nm to 0.36 nm;

wherein a content amount of the vanadium sulfate (II) in the vanadium solid salt composite is in a range of 56.0% by mass to 83.0% by mass.

### BRIEF DESCRIPTION OF DRAWINGS

FIG. 1 is a schematic view depicting the overall configuration of a test vanadium solid-salt battery.

FIG. 2 depicts X-ray diffraction spectra of vanadium solid salts, each containing phosphoric acid and sulfuric acid, which are measured by using CuK α ray as a X-ray source (wavelength λ=0.15418 nm) and at a diffraction angle 2θ, wherein the concentration of the phosphoric acid is different among the vanadium solid salts.

FIG. 3 depicts Raman spectrum of TOKA Black (TB) measured by Raman spectroscopy.

FIG. 4 depicts Raman spectrum of Acetylene Black (AB) measured by the Raman spectroscopy.

FIG. 5 depicts Raman spectrum of Ketjen Black (KB) measured by the Raman spectroscopy.

FIG. 6A depicts XRD spectrum of TOKA Black and FIG. 6B depicts a full width at half maximum (FWHM) of TOKA Black.

FIG. 7A depicts XRD spectrum of Acetylene Black and FIG. 7B depicts a full width at half maximum (FWHM) of Acetylene Black.

FIG. 8A depicts XRD spectrum of Ketjen Black and FIG. 8B depicts a full width at half maximum (FWHM) of Ketjen Black.

FIG. 9 depicts the charging/discharging capacity (relationship between capacity (mAh) and voltage (V)) of a vanadium solid-salt battery of Example, and depicts the coulombic efficiency by constant current charging/discharging.

FIG. 10 depicts the charging/discharging capacity (relationship between capacity (mAh) and voltage (V)) of a vanadium solid-salt battery of Comparative Example, and depicts the coulombic efficiency by constant current charging/discharging.

FIG. 11 depicts the charging/discharging capacity (relationship between capacity (mAh) and voltage (V)) of the vanadium solid-salt battery of Example, and depicts the capacity maintenance rate by constant current charging/discharging.

FIG. 12 depicts the charging/discharging capacity (relationship between capacity (mAh) and voltage (V)) of the vanadium solid-salt battery of Comparative Example, and depicts the capacity maintenance rate by constant current charging/discharging.

### DESCRIPTION OF THE PREFERRED EMBODIMENTS

[Vanadium Solid-Salt Battery]

A vanadium solid-salt battery includes a positive electrode and a negative electrode; and vanadium solid salt which is included in each of the positive and negative electrodes and which contains vanadium ion and/or cation including vanadium, an electrolyte, and a carbon material. The vanadium solid-salt battery includes a separator which partitions the positive electrode from the negative electrode. Further, the vanadium solid-salt battery includes lead-out electrodes in the positive and negative electrodes, respectively.

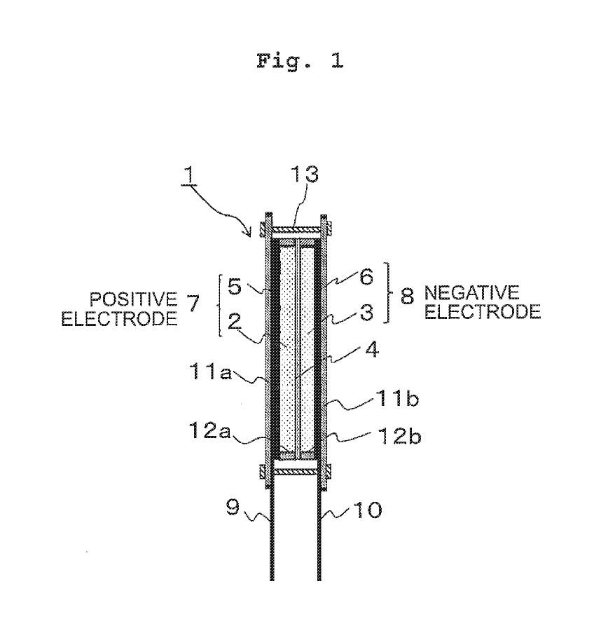

FIG. 1 is a schematic view depicting the overall configuration of a vanadium solid-salt battery. The vanadium solid-salt battery is not limited to the example depicted in FIG. 1.

As depicted in FIG. 1, a vanadium solid-salt battery 1 is provided with a positive electrode 7 including vanadium solid salt 2 for positive electrode (hereinafter referred as the “positive-side vanadium solid salt 2” as appropriate), a negative electrode 8 including vanadium solid salt 3 for negative electrode (hereinafter referred as the “negative-side vanadium solid salt 3” as appropriate) and a separator 4 which partitions the positive-side vanadium solid salt 2 from the negative-side vanadium solid salt 3. The vanadium solid-salt battery 1 can be produced in the following manner.

Firstly, the positive electrode 7 of the vanadium solid-salt battery 1 can be produced in the following manner. Regarding the positive electrode 7 of the vanadium solid-salt battery 1, a first current collector 5 is placed on a first cell plate 11a which forms the cell; next, a first frame 12a is placed on the first current collector 5. Further, a pasty composite for vanadium solid salt (hereinafter referred also as to “vanadium solid salt pasty-composite” as appropriate), which composes the positive-side vanadium solid salt 2 is filled into the inside of the first frame 12a. The vanadium solid salt-pasty composite filled inside the first frame 12a becomes solid, thereby forming the positive-side vanadium solid salt 2.

The positive electrode 7 is provided with a first lead-out electrode 9 between the first current collector 5 and the first cell plate 11a.

The negative electrode 8 of the vanadium solid-salt battery 1 can be produced similarly to the production of the positive electrode 7. Firstly, regarding the negative electrode 8 of the vanadium solid-salt battery 1, a second current collector 6 is placed on a second cell plate 11b which forms the cell; next, a second frame 12b is placed on the second current collector 6. Further, a vanadium solid salt-pasty composite, which composes the negative-side vanadium solid salt 3 is filled into the inside of the second frame 12b. The vanadium solid salt-pasty composite filled inside the second frame 12b becomes solid, thereby forming the negative-side vanadium solid salt 3.

The negative electrode 8 is provided with a second lead-out electrode 10 between the second current collector 6 and the second cell plate 11b.

In the vanadium solid-salt battery 1 depicted in FIG. 1, the separator 4 is sandwiched between the positive-side vanadium solid salt 2 and the negative-side vanadium solid salt 3. In the vanadium solid-salt battery 1 depicted in FIG. 1, peripheral portions of the first and second cell plates 11a and 11b are fixed by a plurality of screws 13.

In the vanadium solid-salt battery 1, the following reactions occur in the positive and negative electrodes, respectively.

Positive electrode:

VOX₂.nH₂O(s) [symbol] VO₂X.(n−1)H₂O(s)+HX+H⁺+e⁻ (3)

Negative electrode:

VX₃.nH₂O(s)+H⁺+e⁻ [symbol] VX₂.nH₂O(s)+HX (4)

In the reaction formulae of the reactions occurring in the positive and negative electrodes, “X” represents a monovalent anion. Note that, however, even in a case that “X” is an m-valent anion, it is allowable to understand that coupling coefficient (1/m) is considered. Further, in the present specification, the symbol “ [symbol] ” rep chemical equilibrium. In the formulae, however, the term “chemical equilibrium” means a state in which, in reversible reaction, an amount of change in a product coincides with an amount of change in a starting material. Further, in the reaction formulae, “n” indicated that “n” can take various values.

Reaction formulae indicated below are of an embodiment of the vanadium solid-salt battery. The following reaction formulae indicate the reactions in the positive electrode.

VOSO₄.nH₂O(s) [symbol] VOSO₄.nH₂O(aq) [symbol] VOSO₄(aq)+nH₂O(aq) (5)

(VO₂)₂.SO₄.nH₂O(s) [symbol] (VO₂)₂.SO₄.nH₂O(aq) [symbol] (VO₂)₂SO₄(aq)+nH₂O(aq) (6)

VO²⁺(aq)+VO₂⁺(aq) [symbol] VO₂O₃³⁺(aq) (7)

VOSO₄(aq) [symbol] VO²⁺(aq)+SO₄²⁻(aq) (8)

(VO₂)₂SO₄(aq) [symbol] 2VO₂⁺(aq)+SO₄²⁻(aq) (8-1)

VO²⁺(aq)+H₂O [symbol] VO₂⁺(aq)+2H⁺ (9)

Reaction formulae indicated below are of an embodiment of the vanadium solid-salt battery. The following reaction formulae indicate the reactions in the negative electrode.

V₂(SO₄)₃.nH₂O(s) [symbol] V₂(SO₄)₃.nH₂O(aq) [symbol] V₂(SO₄)₃+nH₂O(aq) (10)

VSO₄.nH₂O(s) [symbol] VSO₄.nH₂O(aq) [symbol] VSO₄(aq)+nH₂O(aq) (11)

V₂(SO₄)₃(aq) [symbol] 2V³⁺(aq)+3SO₄²⁻ (12)

V³⁺(aq)+e⁻ [symbol] V²⁺(aq) (12-1)

V²⁺(aq)₊SO₄²⁻ [symbol] VSO₄(aq) (12-2)

[Vanadium Solid Salt]

The vanadium solid salts composing the positive and negative electrodes, respectively, each contain vanadium ion or cation including vanadium, a carbon material and an electrolyte. In the present specification, the term “vanadium solid salt” means a substance which contains a compound containing the vanadium ion or the cation including vanadium, a carbon material and an electrolyte, and which is in a solid state. Further, in the present specification, the term “vanadium solid salt composite” means a substance which contains a compound containing the vanadium ion or the cation including vanadium, a carbon material and an electrolyte, and which is in a state before being solidified or in a pre-solid state. The term “state before being solidified” or “pre-solid state” means, for example, a pasty state in which the compound containing the vanadium ion or the cation including vanadium, the carbon material and the electrolyte are mixed.

The carbon material is carbon powder of which R value (degree of graphitization) obtained by the Raman spectroscopy is not more than 1.10 or of which interplanar spacing d (d002) measured by the X-ray powder diffraction is in a range of 0.33 nm to 0.36 nm.

The degree of graphitization of a carbon material is generally represented by an R value (R=I_{D}/I_{G}) that is a strength ratio of D band (a peak appearing at approximately 1350 cm⁻¹) to G band (a peak appearing at approximately 1580 cm⁻¹) in a Raman spectrum obtained by the Raman spectroscopy. The G band reflects a planar structure (three-dimensional ordered structure) of a sp²-bonding of carbons in a carbon material. Further, the D band reflects any disturbance in crystal. Furthermore, there are such cases that a 2D band (a peak appearing at approximately 2685 cm⁻¹) is also present in the Raman spectrum of carbon material. The 2D band also reflects any disturbance in crystal. Regarding a carbon material of which R value is small, there is an indication that such a carbon material has a high degree of graphitization, namely, has a high degree of crystallinity.

In a carbon material of which R value obtained by the Raman spectroscopy is not more than 1.10 and of which degree of crystallinity is relatively high, the bonding between carbons is formed sufficiently, and the ratio of a basal surface to an edge surface in the laminated structure of carbons is also great. Therefore, in the carbon powder of which R value obtained by the Raman spectroscopy is not more than 1.10, an amount of any functional group bondable with carbon and/or an amount of oxygen adsorbable to carbon are/is small. This carbon powder is capable of suppressing, for example in the positive electrode, the reduction (de-oxidization, discharging) of pentavalent vanadium oxide ion (VO₂⁺) in a charged state into tetravalent vanadium oxide ion (VO²⁺). Further, the carbon powder is capable of suppressing, for example in the negative electrode, the oxidization (discharging) of divalent vanadium ion (V²⁺) in a charged state into trivalent vanadium ion (V³⁺). In carbon powder of which R value obtained by the Raman spectroscopy exceeds 1.10, the bonding between carbons is dissolved, and a ratio of carbon bondable with the functional group and/or a ratio of carbon capable of adsorbing oxygen thereto are/is increased. Such carbon powder causes an active material to be oxidized and/or reduced due to the increased ratio(s) of the functional group and/or the oxygen which are contained in the carbon powder and which contribute respectively to the oxidization and reduction. Accordingly, the carbon powder of which R value obtained by the Raman spectroscopy exceeds 1.10 cannot suppress the reduction of pentavalent vanadium oxide ion in the charged state in the positive electrode, and/or cannot suppress the oxidization of divalent vanadium ion in the charged stated in the negative electrode. In a battery using the carbon powder of which R value obtained by the Raman spectroscopy exceeds 1.10, the balance of the redox state in battery is destroyed; the capacity in a battery in which the balance of the redox state is destroyed is lowered.

The carbon material preferably has a high degree of crystallinity. The carbon material has the R value which is obtained by the Raman spectroscopy and which is preferably not more than 1.05, more preferably not more than 1.00, further more preferably not more than 0.80, and particularly preferably not more than 0.50. Although the lower limit value of the R value obtained by the Raman spectroscopy is not particularly limited under a condition that the R value is in a measurable range, an R value of an ordinary carbon material obtained by the Raman spectroscopy is not less than 0.10.

The carbon material is a carbon powder of which interplanar spacing d (d002) measured by the X-ray powder diffraction is in a range of 0.33 nm to 0.36 nm.

The interplanar spacing d (d002) measured by the X-ray powder diffraction can be obtained, based on the Bragg equation (I) below, from a peak derived from the c-axis (002) of a diffraction grating spectrum obtained by the X-ray powder diffraction.

d=λ(2×Sin θ_{B}) (I)

(in the equation, “d” represents the interplanar spacing d (d002), “λ” represents a wavelength of 0.154 nm, and “θ_{B}” represents the Bragg angle).

A carbon powder of which interplanar spacing d measured by the X-ray powder diffraction is in the range of 0.33 nm to 0.36 nm has a planar structure of sp²-bonding of carbons. That indicates that this carbon powder has a structure similar to that of a natural graphite exhibiting the three-dimensional ordered structure, and has a high degree of crystallinity. The c-axis (002) interplanar spacing d (d002) of an ideal natural graphite powder is 0.3354 nm. As a carbon powder has a c-axis (002) interplanar spacing d (d002) which takes a value closer to 0.3354 nm, the degree of crystallinity of the carbon power becomes greater.

The carbon powder of which interplanar spacing d measured by the X-ray powder diffraction is in the range of 0.33 nm to 0.36 nm has a crystalline structure close to the three-dimensional ordered structure and is in a highly stable state. This carbon powder is capable of maintaining the balance in the redox state of the vanadium ion or the cation including vanadium in the positive or negative electrode. In carbon powder of which interplanar spacing d measured by the X-ray powder diffraction is less than 0.33 nm or is more than 0.36 nm has a disturbed crystalline structure. In a battery using the carbon powder of which crystalline structure is disturbed, the balance in the redox state of the vanadium ion or the cation including vanadium is destroyed in the positive or negative electrode, and thus the capacity in such a battery is lowered.

In a carbon material of which degree of crystallinity is relatively high, the bonding between carbons is formed sufficiently, and the ratio of the basal surface to the edge surface in the laminated structure of carbons is also great. Therefore, in the carbon powder of which degree of crystallinity is relatively high, an amount of any functional group bondable with carbon and/or an amount of oxygen adsorbable to carbon are/is small. In the carbon powder of which interplanar spacing d (d002) is less than 0.33 nm or is more than 0.36 nm, the bonding between carbons is dissolved, and a ratio of carbon bondable with the functional group and/or a ratio of carbon capable of adsorbing oxygen thereto are/is increased. In a case that the ratio of the functional group and/or the ratio of the oxygen contributing respectively to the oxidization and reduction in the carbon powder are/is increased, and that a battery uses such carbon powder, an active material in the battery is oxidized and/or reduced.

The R value obtained by the Raman spectroscopy and the interplanar spacing d measured by the X-ray powder diffraction are both indexes indicating the degree of crystallinity of carbon powder. The R value of the carbon powder obtained by the Raman spectroscopy indicates a state of crystal in the surface of the carbon powder. Further, the interplanar spacing d (d002) of the carbon powder measured by the X-ray powder diffraction indicates a state of crystal in the inside of the carbon powder. As the carbon powder, it is preferable to use such carbon powder satisfying the following two values that are the R value obtained by the Raman spectroscopy which is not more than 1.10 and the interplanar spacing d (d002) measured by the X-ray powder diffraction which is in the range of 0.33 nm to 0.36 nm.

The kind, etc. of the carbon material is not particularly limited under a condition that the carbon material is a carbon powder of which R value obtained by the Raman spectroscopy is not more than 1.10 or that of which interplanar distance d (d002) measured by the X-ray powder diffraction is in the range of 0.33 nm to 0.36 nm. The carbon powder is exemplified, for example, by natural graphite, graphitized carbon black, acetylene black, etc. A commercially available graphitized carbon black is exemplified, for example, by TOKA Black (trade name) #3855, TOKA Black (trade name) #3845, TOKA Black (trade name) #3800 (manufactured by TOKAI CARBON CO., LTD.), etc.

The content amount of the carbon material, to 100% by mass of the vanadium solid salt or 100% by mass of the vanadium solid salt composite, is in a range of 1% by mass to 42% by mass. The content amount of the carbon material, to 100% by mass of the vanadium solid salt or 100% by mass of the vanadium solid salt composite is preferably in a range of 2% by mass to 41% by mass, is more preferably in a range of 3% by mass to 40% by mass, is further more preferably in a range of 4% by mass to 38% by mass, and is most preferably in a range of 5% by mass to 35% by mass. In a case that the content amount of the carbon material in the vanadium solid salt or in the vanadium solid salt composite is less than 1% by mass, the electrons (e) cannot be transmitted, thus lowering the capacity maintenance rate, coulombic efficiency and energy efficiency. On the other hand, in a case that the content amount of the carbon material in the vanadium solid salt or in the vanadium solid salt composite exceeds 42% by mass, the amount of vanadium ion or cation including vanadium contained in the vanadium solid salt becomes small, thus lowering the battery capacity.

The positive-side vanadium solid salt or a vanadium solid salt composite for positive electrode (hereinafter referred to also as “positive-side vanadium solid salt composite” as appropriate) preferably uses a compound containing cation including vanadium of which oxidation number is changed between tetravalence and pentavalence. The cation including vanadium of which oxidation number is changed between tetravalence and pentavalence can be exemplified by VO²⁺ (IV) and VO₂⁺ (V). A vanadium compound used for the positive-side vanadium solid salt can be exemplified by vanadium oxide sulfate (IV) (VOSO₄.nH₂O) and vanadium oxide sulfate (V) ((VO₂)₂SO₄.nH₂O) wherein “n” represents an integer in a range of 1 to 6.

The content amount of vanadium oxide sulfate (IV), to 100% by mass of the positive-side vanadium solid salt or 100% by mass of the positive-side vanadium solid salt composite, is in a range of 57.0% by mass to 85.0% by mass. The content amount of vanadium oxide sulfate (IV), to 100% by mass of the positive-side vanadium solid salt or 100% by mass of the positive-side vanadium solid salt composite, is preferably in a range of 58.0% by mass to 84.0% by mass, is more preferably in a range of 60.0% by mass to 83.0% by mass, and is further more preferably in a range of 62.0% by mass to 82.0% by mass. In a case that the content amount of the vanadium oxide sulfate (IV) is in the range of 57.0% by mass to 85.0% by mass, a required battery capacity can be satisfied.

The negative-side vanadium solid salt or a vanadium solid salt composite for negative electrode (hereinafter referred also to as “negative-side vanadium solid salt composite” as appropriate) preferably uses a compound containing vanadium ion of which oxidation number is changed between divalence and trivalence. The vanadium ion of which oxidation number is changed between divalence and trivalence can be exemplified by V²⁺ (II) and V³⁺ (III). A vanadium compound used for the negative-side vanadium solid salt can be exemplified by vanadium sulfate (II) (VSO₄.nH₂O) and vanadium sulfate (III) (V₂(SO₄)₃.nH₂O) wherein “n” represents an integer in a range of 1 to 6.

The content amount of vanadium sulfate (III), to 100% by mass of the negative-side vanadium solid salt or 100% by mass of the negative-side vanadium solid salt composite, is in a range of 56.0% by mass to 83.0% by mass. The content amount of vanadium sulfate (III), to 100% by mass of the negative-side vanadium solid salt or 100% by mass of the negative-side vanadium solid salt composite, is preferably in a range of 57.0% by mass to 82.0% by mass, is more preferably in a range of 60.0% by mass to 81.0% by mass, and is further more preferably in a range of 62.0% by mass to 80.5% by mass. Regarding the vanadium solid-salt battery, in a case that the content amount of the vanadium sulfate (III) in the negative-side vanadium solid salt or in the negative-side vanadium solid salt composite is in the range of 56.0% by mass to 83.0% by mass, a required battery capacity can be satisfied.

The vanadium solid salt contains an electrolyte. The content amount of the electrolyte, to 100% by mass of the vanadium solid salt or 100% by mass of the vanadium solid salt composite, is preferably in a range of 1% by mass to 30% by mass, is more preferably in a range of 2% by mass to 25% by mass, and is further more preferably in a range of 3% by mass to 20% by mass. Regarding the vanadium solid-salt battery, in a case that the content amount of the electrolyte, in the vanadium solid salt or in the vanadium solid salt composite in the vanadium solid-salt battery, is in the range of 1% by mass to 30% by mass, the required battery capacity can be satisfied and the cycle characteristic of battery can be prolonged as well.

The electrolyte contains sulfuric acid. As the sulfuric acid, it is possible to use a diluted sulfuric acid aqueous solution and/or concentrated sulfuric acid aqueous solution. As the concentrated sulfuric acid, it is possible to use commercially available concentrated sulfuric acid of which percent concentration of mass is in a range of 96% by mass to 98% by mass. Any commercially available concentrated sulfuric acid generally has a mol concentration of 18 mol/L.

The volume mole concentration of sulfuric acid in the electrolyte contained in the positive-side vanadium solid salt or the positive-side vanadium solid salt composite is preferably in a range of 0.34 mol/L to 0.80 mol/L, is more preferably in a range of 0.4 mol/L to 0.78 mol/L, is further more preferably in a range of 0.45 mol/L to 0.76 mol/L, and is particularly preferably in a range of 0.50 mol/L to 0.75 mol/L.

The volume mole concentration of sulfuric acid in the electrolyte contained in the negative-side vanadium solid salt or the negative-side vanadium solid salt composite is preferably in a range of 1.83 mol/L to 2.24 mol/L, is more preferably in a range of 1.80 mol/L to 2.23 mol/L, is further more preferably in a range of 1.90 mol/L to 2.22 mol/L, and is particularly preferably in a range of 1.97 mol/L to 2.20 mol/L.

In a case that the volume mole concentration of sulfuric acid in the electrolyte in the positive electrode is in the range of 0.34 mol/L to 0.80 mol/L and that the volume mole concentration of sulfuric acid in the electrolyte in the negative electrode is in the range of 1.83 mol/L to 2.24 mol/L, the required battery capacity can be satisfied and the cycle characteristic of battery can be prolonged as well.

The positive-side vanadium solid salt or positive-side vanadium solid salt composite and the negative-side vanadium solid salt or negative-side vanadium solid salt composite are different from each other in the volume mole concentration of sulfuric acid contained in the electrolyte thereof. The volume mole concentration of sulfuric acid contained in the electrolyte in the positive electrode is made to be different from the volume mole concentration of sulfuric acid contained in the electrolyte in the negative electrode, for the purpose of suppressing the movement of water from the negative electrode to the positive electrode during the charging.

The positive electrode uses water in the reaction wherein the tetravalent vanadium oxide ion is oxidized (charged) to the pentavalent vanadium oxide, as indicated in the following formula (13).

VO²⁺(tetravalent)+H₂O [symbol] VO₂⁺(pentavalent)+2H⁺+e⁻ (13)

In the vanadium solid-salt battery, in a case that the acid concentration is same in the positive and negative electrodes in the initial state, the acid concentration in the positive electrode becomes relatively higher than that in the negative electrode during the charging. In the vanadium solid-salt battery, if the acid concentration in the positive electrode becomes higher during the charging, water is caused to move from the negative electrode to the positive electrode so as to maintain the balance in the acid concentration between the positive and negative electrodes. In the vanadium solid-salt battery, the reason for allowing the volume mole concentration of sulfuric acid in the electrolyte in the positive electrode to be different from that in the negative electrode is to maintain the balance in the acid concentration between the positive and negative electrode and to thereby suppress the movement of water from the negative electrode to the positive electrode also during the charging (also when the charging is performed).

The electrolyte further contains phosphoric acid or phosphate. As the phosphoric acid, it is possible to use orthophosphoric acid (H₃PO₄). The phosphoric acid is not limited to the orthophosphoric acid, and it is allowable to use condensed phosphoric acid such as straight-chain polyphosphoric acid, cyclic metaphosphoric acid, etc.

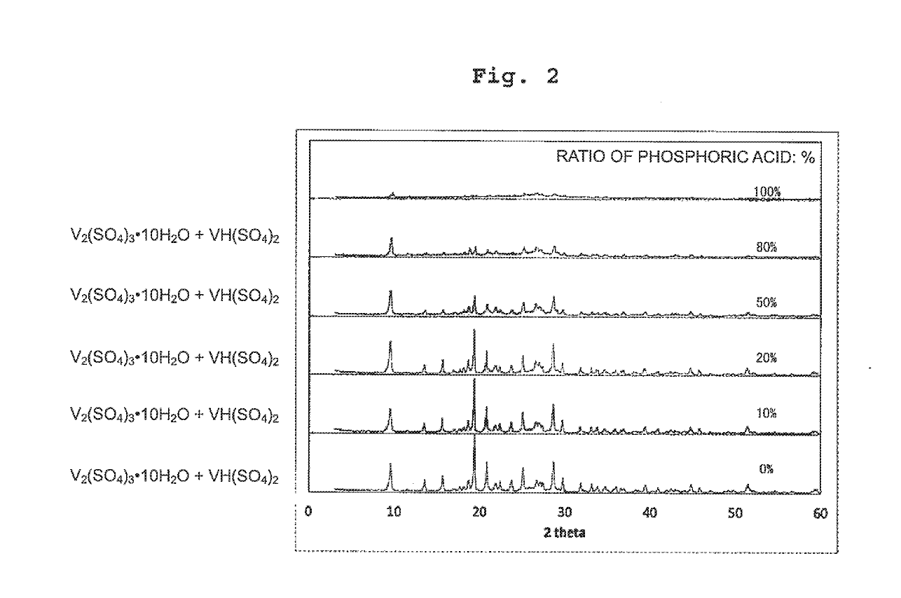

Alternatively, phosphate may be used. As the phosphate, it is allowable to use any one of polyphosphate, metaphosphate and orthophosphate. In a case that phosphoric acid or phosphate is contained in the electrolyte together with sulfuric acid, the crystalline form of the vanadium solid salt is changed as compared with a case of allowing only sulfuric acid to be contained in the electrolyte. For example, in a case of using an electrolyte containing sulfuric acid together with phosphoric acid or phosphate in the positive-side vanadium solid salt, the number of hydrated water in the positive-side vanadium solid salt is changed. Since the number of hydrated water in the positive-side vanadium solid salt is changed, it is estimated that the crystalline form of the positive-side vanadium solid salt is changed. On the other hand, in a case of using an electrolyte containing sulfuric acid together with phosphoric acid in the negative-side vanadium solid salt, the spectrum of vanadium sulfate (III) (V₂(SO₄)₃.10H₂O+VH(SO₄)₂) measured by the X-ray diffraction method takes a broad state as the content amount of phosphoric acid in the electrolyte is greater, as depicted in FIG. 2. In a case that the spectrum of vanadium sulfate (III) measured by the X-ray diffraction method as depicted in FIG. 2 is in the broad state, it is estimated that the crystalline form of the negative-side vanadium solid salt is changed. By allowing the vanadium solid salt to contain the electrolyte containing phosphoric acid or phosphate, the vanadium solid salt is prevented from taking a stable crystalline form. By allowing the vanadium solid salt to contain the electrolyte containing phosphoric acid or phosphate, the vanadium solid salt takes an amorphous form. By allowing the crystalline form of the vanadium solid salt to change to the amorphous form, the electro-chemical reaction is maintained in the vanadium solid salt. Owing to the maintained electro-chemical reaction in the vanadium solid salt, the cycle characteristic of the vanadium solid-salt battery is improved.

The volume mole concentration of phosphoric acid or phosphate in the electrolyte contained in the positive-side vanadium solid salt or in the positive-side vanadium solid salt composite is preferably in a range of 0.20 mol/L to 0.66 mol/L, is more preferably in a range of 0.22 mol/L to 0.6 mol/L, is further more preferably in a range of 0.24 mol/L to 0.55 mol/L, and is particularly preferably in a range of 0.25 mol/L to 0.46 mol/L.

The volume mole concentration of phosphoric acid or phosphate in the electrolyte contained in the negative-side vanadium solid salt or in the negative-side vanadium solid salt composite is preferably in a range of 0.18 mol/L to 0.60 mol/L, is more preferably in a range of 0.20 mol/L to 0.55 mol/L, is further more preferably in a range of 0.22 mol/L to 0.50 mol/L, and is particularly preferably in a range of 0.23 mol/L to 0.46 mol/L.

In a case that the volume mole concentration of phosphoric acid or phosphate in the electrolyte in the positive electrode is in the range of 0.20 mol/L to 0.66 mol/L and that the volume mole concentration of phosphoric acid or phosphate in the electrolyte in the negative electrode is in the range of 0.18 mol/L to 0.60 mol/L, the vanadium solid salt in the positive electrode and the vanadium solid salt in the negative electrode are prevented from taking the stable crystalline form. By allowing the vanadium solid salt in the positive electrode and the vanadium solid salt in the negative electrode to take the amorphous form, the electro-chemical reaction is maintained in the vanadium solid salt in the positive electrode and in the vanadium solid salt in the negative electrode. Owing to the maintained electro-chemical reaction in the vanadium solid salt, the cycle characteristic of the vanadium solid-salt battery is improved.

The molar ratio of phosphoric acid or phosphate to sulfuric acid (sulfuric acid:phosphoric acid or phosphate) in the electrolyte contained in the positive-side vanadium solid salt is preferably in a range of 1:0.25 to 1:1.94, is more preferably in a range of 1:0.29 to 2:1.50. Namely, the molar ratio of phosphoric acid or phosphate to sulfuric acid in the electrolyte contained in the positive-side vanadium solid salt is preferably in a range of (phosphoric acid or phosphate)/(sulfuric acid)=0.25 to 1.94, is more preferably in a range of 0.29 to 1.50. The molar ratio of phosphoric acid or phosphate to sulfuric acid (sulfuric acid:phosphoric acid or phosphate) in the electrolyte contained in the positive-side vanadium solid salt is further more preferably in a range of 1:0.3 to 1:1.2, is particularly preferably in a range of 1:0.33 to 1:1.02. Namely, the molar ratio of phosphoric acid or phosphate to sulfuric acid in the electrolyte contained in the positive-side vanadium solid salt is further more preferably in a range of (phosphoric acid or phosphate)/(sulfuric acid)=0.3 to 1.2, is particularly preferably in a range of 0.33 to 1.02. In a case that the molar ratio of phosphoric acid or phosphate to sulfuric acid in the electrolyte contained in the positive-side vanadium solid salt is in the range of 1:0.25 to 1:1.94, the vanadium solid salt in the positive electrode is allowed to form a satisfactory amorphous form capable of maintaining the electro-chemical reaction. On the other hand, in a case that the molar ratio of phosphoric acid or phosphate to sulfuric acid in the electrolyte contained in the positive-side vanadium solid salt is less than 1:0.25, it is not possible to suppress the taking of a stable crystalline form by the vanadium solid salt. In a case that the positive-side vanadium solid salt takes the stable crystalline form, the electro-chemical reaction is hard to be maintained in the vanadium solid salt in the positive electrode. On the other hand, in another case that the molar ratio of phosphoric acid or phosphate to sulfuric acid contained in the positive-side vanadium solid salt exceeds 1:1.94, the presence ratio of phosphoric acid or phosphate becomes high. Owing to the high existence rate of phosphoric acid or phosphate contained in the positive-side vanadium solid salt, the initial capacity is lowered in such a vanadium solid-salt battery that uses this positive-side vanadium solid salt.

The molar ratio of phosphoric acid or phosphate to sulfuric acid (sulfuric acid:phosphoric acid or phosphate) in the electrolyte contained in the negative-side vanadium solid salt is preferably in a range of 1:0.082 to 1:0.333, is more preferably in a range of 1:0.1 to 1:0.234. Namely, the molar ratio of phosphoric acid or phosphate to sulfuric acid in the electrolyte contained in the negative-side vanadium solid salt is preferably in a range of (phosphoric acid or phosphate)/(sulfuric acid)=0.082 to 0.333, is more preferably in a range of 0.1 to 0.234. In a case that the molar ratio of phosphoric acid or phosphate to sulfuric acid in the electrolyte contained in the negative-side vanadium solid salt is in the range of 1:0.082 to 1:0.333, the vanadium solid salt in the negative electrode is allowed to form a satisfactory amorphous form capable of maintaining the electro-chemical reaction. On the other hand, in a case that the molar ratio of phosphoric acid or phosphate to sulfuric acid in the electrolyte contained in the negative-side vanadium solid salt is less than 1:0.0.082, it is not possible to suppress the taking of a stable crystalline form by the vanadium solid salt. In a case that the negative-side vanadium solid salt takes the stable crystalline form, the electro-chemical reaction is hard to be maintained in the vanadium solid salt in the negative electrode. On the other hand, in another case that the molar ratio of phosphoric acid or phosphate to sulfuric acid in the electrolyte contained in the negative-side vanadium solid salt exceeds 1:0.333, the presence ratio of phosphoric acid or phosphate becomes high. Owing to the high existence rate of phosphoric acid or phosphate contained in the negative-side vanadium solid salt, the initial capacity is lowered in such a vanadium solid-salt battery that uses this negative-side vanadium solid salt.

The vanadium solid salt or the vanadium solid salt composite may further contain a binder. As the binder, it is possible to use a fluorine-based binder, a rubber-based binder, etc. The fluorine-based binder can be exemplified by polytetrafluoroethylene (PTFE), tetrafluoroethylene-hexafluoropropylene copolymer (EFP), tetrafluoroethylene-perfluoroalkylvinylether copolymer (PFA), ethylene/tetrafluoroethylene (ETFE), ethylenechlorotrifluoro-ethylene copolymer (ECTFE), polyvinylidene fluoride (PVDF), polyvinylidene fluoride-hexafluoropropylene copolymer (PVDF-HFP), etc. The rubber-based binder can be exemplified by styrene-butadiene rubber (SBR), ethylene-propylene rubber (EPM), etc. The binder is preferably polytetrafluoroethylene (PTFE), polyvinylidene fluoride (PVDF) and styrene-butadiene rubber (SBR). One kind of the above-described substances may be used as the binder, or two or more kind of the above-described substances may be used together as the binder.

The content amount of the binder to 100% by mass of the vanadium solid salt or 100% by mass of the vanadium solid salt composite, is preferably in a range of 0.1% by mass to 20% by mass, is more preferably in a range of 0.1% by mass to 18% by mass, is further more preferably in a range of 0.1% by mass to 15% by mass, and is most preferably in a range of 0.1% by mass to 10% by mass. In a case that the content amount of the binder in the vanadium solid salt or the vanadium solid salt composite is in the range of 0.1% by mass to 20% by mass, the stability of the vanadium solid salt or the vanadium solid salt composite is improved.

[Method for Producing Vanadium Solid Salt Composite and Vanadium Solid Salt]

A method for producing the vanadium solid salt composite and the vanadium solid salt is not particularly limited. The method for producing the vanadium solid salt composite and the vanadium solid salt includes the following steps. Firstly, the producing method includes a first step of forming a powdery mixture. In this first step, carbon powder and a compound containing vanadium ion or cation containing vanadium are mixed, and pulverized into a powdery form as necessary, thereby obtaining a powdery mixture. Next, the producing method includes a second step of forming a vanadium solid salt-pasty composite. In this second step, an electrolyte is poured into the powdery mixture, thereby obtaining the vanadium solid salt-pasty composite. Further, as necessary, this producing method includes a third step of forming a powdery mixture added with a binder, etc. In this third step, the binder and another additive, etc., are added to and mixed with the vanadium solid salt-pasty composite, thereby obtaining the mixture. Afterwards, the producing method includes a fourth step of obtaining a vanadium solid salt. In this fourth step, the vanadium solid salt-pasty composite is dried, thereby obtaining the vanadium solid salt. The vanadium solid salt-pasty composite is dried under the atmospheric pressure (about 1.01×10⁵ Pa) at a temperature in a range of normal temperature (about 20 degrees Celsius) to 180 degrees Celsius. In a case that the vanadium solid salt-pasty composite is to be heated up to a temperature not less than the normal temperature, the vanadium solid salt-pasty composite may be heated by using, for example, a hot plate, etc. Further, the vanadium solid salt-pasty composite may be dried in a vacuum state. Here, the term “vacuum state” means being under a pressure lower than the atmospheric pressure, and is preferably not more than a degree of vacuum of 1×10⁵ Pa. The vanadium solid salt-pasty composite can be dried at a pressure during the drying in a range of about 1×10² Pa to about 1×10⁵ Pa, by using all purpose means (widely used means) such as an aspirator, a vacuum pump, etc.

[Separator]

The vanadium solid-salt battery includes a separator (separation membrane) which separates (partitions) the positive electrode from the negative electrode and which allows hydrogen ions (protons) to pass therethrough. It is allowable to use, as the separator, any separator provided that the separator allows the hydrogen ions (proton) to pass therethrough. As the separator, it is allowable to use a porous membrane, a nonwoven fabric, or an ion-exchange membrane which selectively allows the hydrogen ions to pass therethrough. The porous membrane can be exemplified, for example, by a microporous film (membrane) formed of polyethylene (manufactured by ASAHI KASEI CORPORATION), etc. Further, the nonwoven fabric can be exemplified, for example, by “NanoBase (trade name)” (manufactured by MITSUBISHI PAPER MILLS LIMITED). Furthermore, the ion-exchange membrane can be exemplified, for example, by “SELEMION (trade name) APS” (manufactured by ASAHI GLASS CO., LTD.), “NEOSEPTA (trade name) CMX” (manufactured by ASTOM CORPORATION), and the like.

[Current Collector]

As the current collector, it is possible to use a current collector formed of a conductive rubber, a current collector formed of a graphite sheet, etc. The conductive rubber is preferably a sheet-shaped conductive rubber. The thickness of the conductive rubber or the thickness of the graphite sheet is not particularly limited. However, the thickness of the conductive rubber or the thickness of the graphite sheet is preferably in a range of 10 μm to 150 μm, more preferably in a range of 20 μm to 120 μm, further more preferably in a range of 30 μm to 100 μm.

[Lead-Out Electrode]

As the lead-out electrode, it is allowable to use a metallic foil. The metal constructing the metallic foil can be exemplified by copper, aluminum, silver, gold, nickel, stainless steel, and the like which have small resistance. The metallic foil is preferably copper foil or aluminum foil which is not expensive. Further, the thickness of the metallic foil is preferably in a range of 10 μm to 150 μm, more preferably in a range of 20 μm to 120 μm, further more preferably in a range of 30 μm to 100 μm.

In the vanadium solid-salt battery, the current collector and the lead-out electrode can be used in combination. The combination of the current collector and lead-out electrode can be exemplified, for example, by a combination of a conductive rubber and a metallic foil, or a combination of a graphite sheet and a metallic foil. The combination of conductive rubber and metallic foil, or the combination of graphite sheet and metallic foil, can lower the resistance in the battery. It is preferable to select the combination of conductive rubber and metallic foil, or the combination of graphite sheet and metallic foil, since the combination can lower the resistance in the battery. In a case that a metal is used for a plate constructing the cell, it is allowable that the vanadium solid-salt battery does not use any lead-out electrode.

[Cell]

As the plate constructing the cell, any conductive material or any insulating material can be used. A metallic plate is preferable as the conductive material. The metal constructing the metallic plate can be exemplified by copper, aluminum, silver, gold, nickel, stainless steel (SUS303, SUS314, SUS316L, etc.), and the like.

The insulating material can be exemplified by polyethylene, polypropylene, polyvinyl chloride, engineering plastic, etc.

As the frame constructing the cell, an insulating material can be used. The insulating material can be exemplified by polyethylene, polypropylene, polyvinyl chloride, engineering plastic, etc.

Since the vanadium solid-salt battery of the present disclosure includes, in the vanadium solid salt, a specified amount of the carbon powder of which R value obtained by the Raman spectroscopy is the specified value or of which interplanar spacing d (d002) measured by the X-ray powder diffraction is in the specified value, it is possible to thereby maintain the balance of the redox state of the vanadium ion or the cation including vanadium in the positive and negative electrodes. Since the vanadium solid-salt battery of the present disclosure maintains the balance of the redox state of the vanadium ion or the cation including vanadium in the positive and negative electrodes, it is thereby possible to improve the capacity maintenance rate, coulombic efficiency and energy efficiency.

As described above, the vanadium solid salt of the present disclosure contains the specified amount of the carbon powder composed of the carbon material of which R value obtained by the Raman spectroscopy is not more than 1.10 or of which interplanar spacing d (d002) measured by the X-ray powder diffraction is in the range of 0.33 nm to 0.36 nm. The vanadium solid salt-battery of the present disclosure is capable of maintaining the balance of the redox state of the vanadium ion or the cation including vanadium in the positive and negative electrodes. The vanadium solid salt-battery of the present disclosure is capable of improving the capacity maintenance rate, coulombic efficiency and energy efficiency of the vanadium solid-salt battery.

### Examples

Next, a specific aspect of the present disclosure will be explained based on an example together with a comparative example. However, the present disclosure is not limited by and is not restricted to the example and comparative example.

[Carbon Powder]

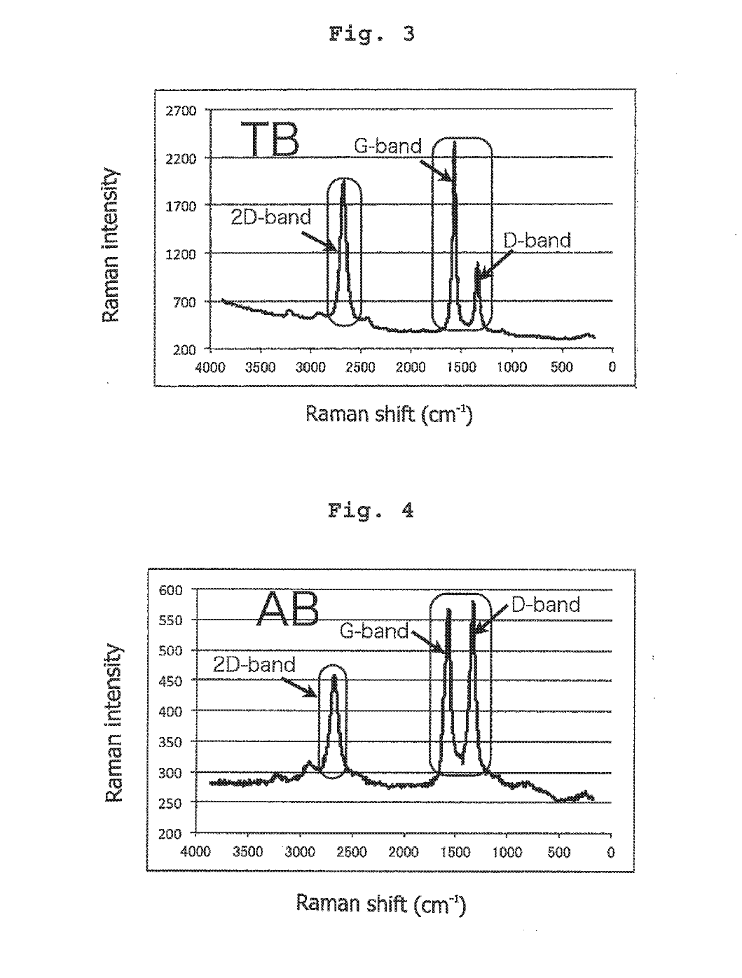

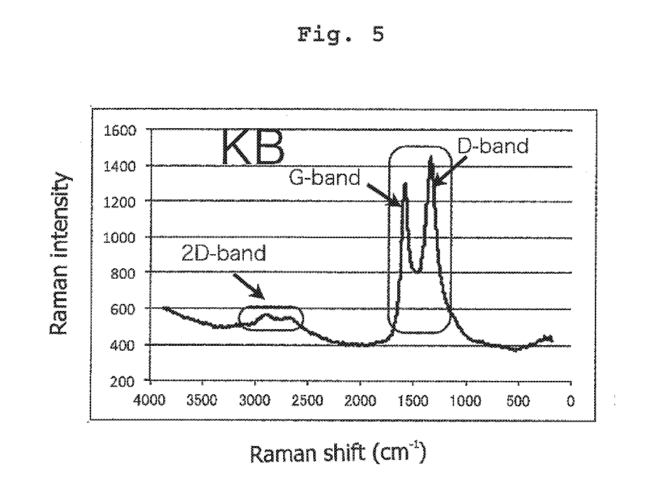

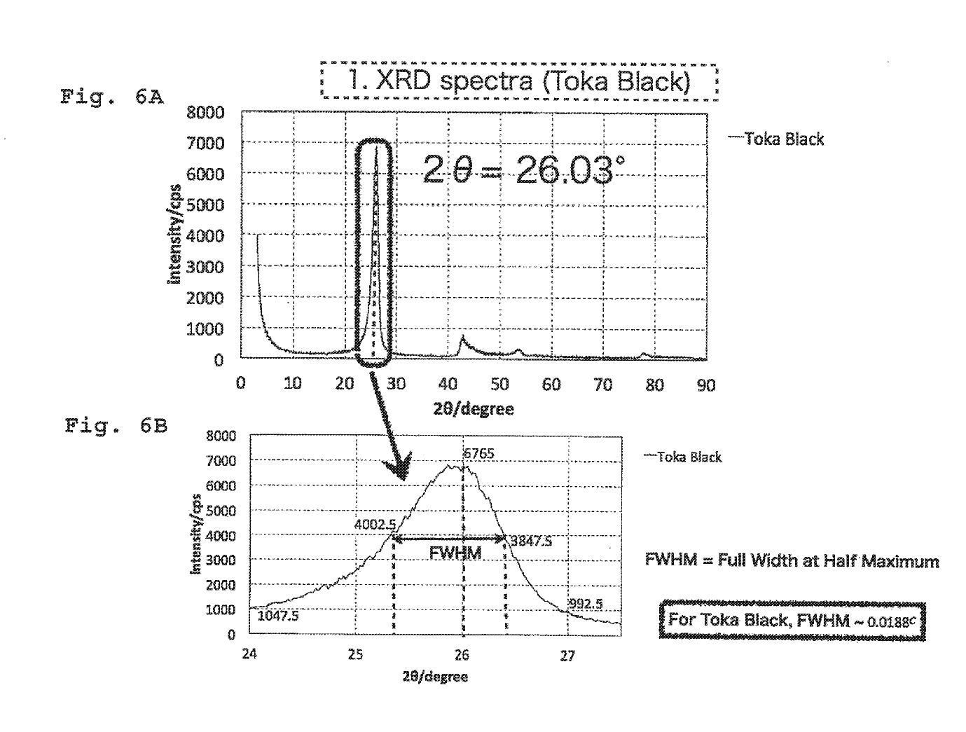

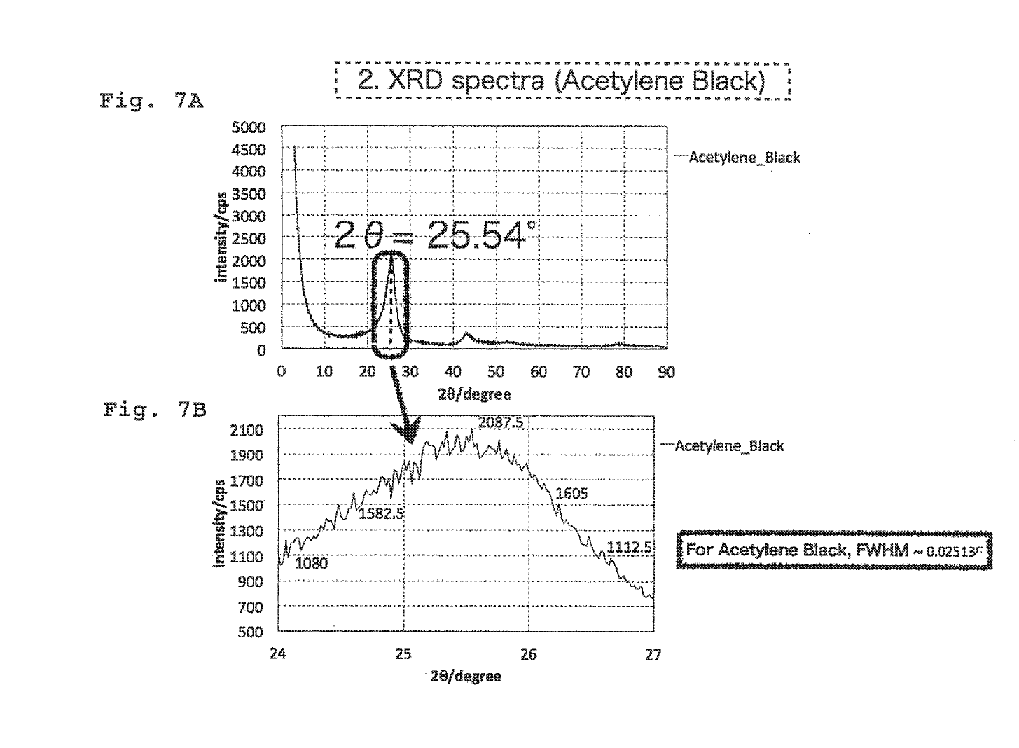

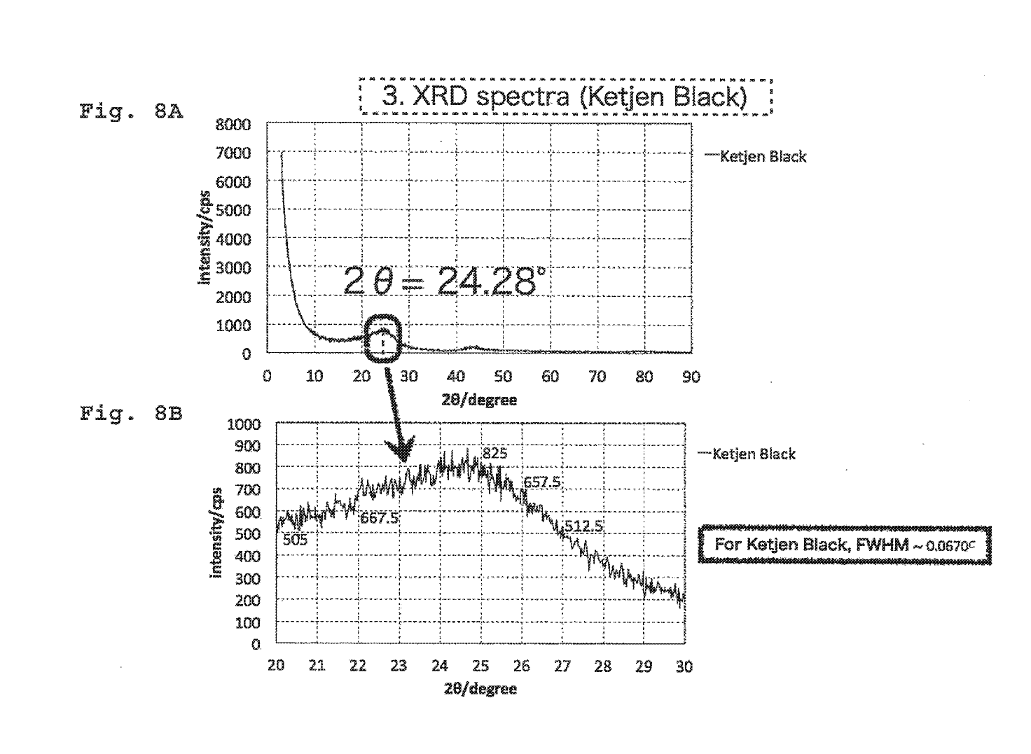

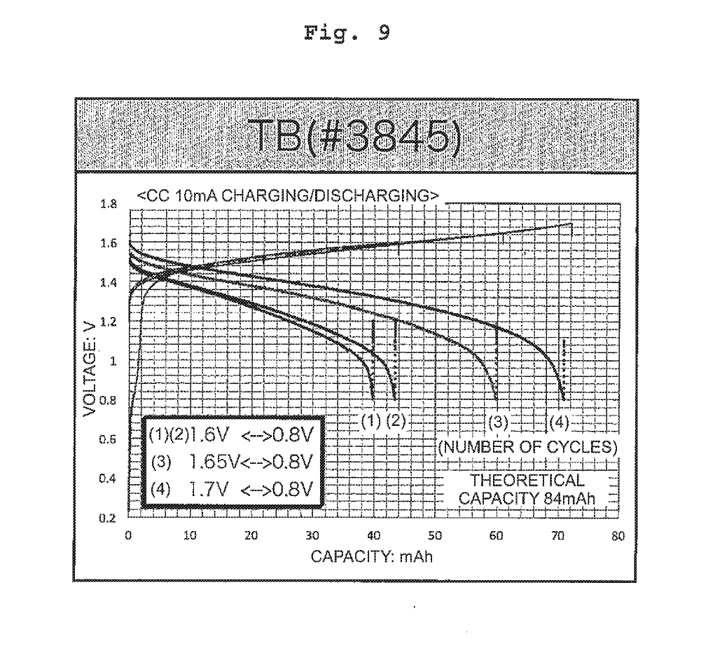

Carbon powders No. 1 to No. 3 as described below were subjected to measurements of the R value by the Raman spectroscopy and of the interplanar spacing d by the X-ray powder diffraction. FIG. 3 depicts a Raman spectrum of a graphitized carbon black (TOKA Black (trade name; indicated as “TB” in FIG. 3), as the carbon powder No. 1, measured by the Raman spectroscopy. FIG. 4 depicts a Raman spectrum of Acetylene Black (indicated as “AB” in FIG. 4), as the carbon powder No. 2, measured by the Raman spectroscopy. FIG. 5 depicts a Raman spectrum of Ketjen Black (indicated as “KB” in FIG. 5), as the carbon powder No. 3, measured by the Raman spectroscopy. FIG. 6A depicts an XRD spectrum of TOKA Black as the carbon powder No. 1 and FIG. 6B depicts a full width at half maximum (FWHM) of TOKA Black. FIG. 7A depicts XRD spectrum of Acetylene Black as the carbon powder No. 2 and FIG. 7B depicts a full width at half maximum (FWHM) of Acetylene Black. FIG. 8A depicts an XRD spectrum of Ketjen Black as the carbon powder No. 3 and FIG. 8B depicts a full width at half maximum (FWHM) of Ketjen Black. TABLE 3 indicates the R values measured by the Raman spectroscopy and the values of the interplanar spacings d measured by the X-ray powder diffraction of the carbon powders Nos. 1 to 3.

Carbon Powder No. 1: Graphitized carbon black (TOKA Black (trade name) #3845 (manufactured by TOKAI CARBON CO., LTD.; arithmetic average particle diameter (volume accumulation average particle diameter obtained by the Laser diffraction scattering method): 40 μm)

Carbon Powder No. 2: Acetylene black (DENKA Black (trade name) HS-100 (manufactured by DENKA CO., LTD.; average particle diameter: 0.048 μm)

Carbon Powder No. 3: Ketjen black (Ketjen Black (trade name) EC300J (manufactured by LION SPECIALTY CHEMICALS CO., LTD.; average particle diameter: 0.0395 μm)

[Raman Spectroscopy]

The carbon powders No. 1 to No. 3 were subjected to the measurement by the Raman spectroscopy with the following apparatus and under the following conditions.

### [Apparatus]

Laser Raman Spectrometer NSR-3100 (manufactured by JASCO CORPORATION)

Equipped with two lasers (532 nm, 785 nm)

Notch filter: 2 pieces

Wavelength resolution: 1 cm⁻¹; Depth direction resolution: 1 μm

Objective lens: ×5, ×20, ×100

Automatic XYZ stage (step: 0.1 μm)

Equipped with attachment for polarization measurement

### [Measurement Method]

Each of test samples for measurement was filled inside a measurement cell by allowing each of the carbon powders to free-fall into the measurement cell. Each of the measurement samples was subjected to the measurement by the Raman spectroscopy by irradiating the inside of the measurement cell with an Argon ion laser beam and by rotating the measurement cell in a plane perpendicular to the laser beam. The measurement conditions are as indicated below.

Wavelength of Argon ion laser beam: 532 nm, 785 nm

Measurement range: 180 cm⁻¹ to 3800 cm⁻¹

Peak strength measurement, Peak half-width measurement: Background processing, Smoothing processing

[Raman R Value]

The Raman R value is defined as a strength ratio I_{D}/I_{G} of strength I_{D} of maximum peak appearing at approximately 1350 cm⁻¹ to strength I_{G} of maximum peak appearing at approximately 1580 cm⁻¹ in the Raman spectrum obtained by the Raman spectroscopy.

[X-Ray Powder Diffraction]

The carbon powders No. 1 to No. 3 were subjected to the measurement by the X-ray powder diffraction with the following apparatus and under the following conditions.

### [Apparatus]

X-ray Diffractometer MiniFlex II (manufactured by RIGAKU CORPORATION)

X-ray source: CuK α ray (wavelength λ=0.15418 nm)

Diffraction intensity was measured by the 2θ method regarding the scanning speed of 2θ, at 4 degrees/min, in a range of 3 degrees to 90 degrees at 0.02 degree interval.

### [Measurement Method]

With respect to the test samples for measurement, each of the carbon powders No. 1 to No. 3 was placed, in an appropriate amount, in a sample cup made of silica glass having a rectangular shape of which one side in the bottom surface is 20 mm and having the depth is 0.1 mm, to be filled in the sample cap so that the height of each of the carbon powders No. 1 to No. 3 was matched with the silica glass surface by using a spatula. The measurement of each of the test samples for measurement was performed by using the X-ray diffractometer.

The interplanar spacing d (d002) of each of the carbon powders No. 1 to No. 3 measured by the X-ray powder diffraction was obtained, based on the Bragg equation (I) indicated below, from a peak derived from the c-axis (002) of a diffraction grating spectrum obtained by the X-ray powder diffraction.

d=λ(2×Sin θ_{B}) (I)

(in the equation, “d” represents interplanar spacing d (d002), “λ” represents a wavelength of 0.154 nm, and “θ_{B}” represents the Bragg angle).

TABLE 1 as follows indicates the graphitization temperature, the Bragg angle, the interplanar spacing d (d002) obtained based on the Bragg equation (I) of each of the graphitized carbon, the carbon powder No. 1 (graphitized carbon black (TOKA Black)), the carbon powder No. 2 (acetylene black) and the carbon powder No. 3 (Ketjen black). Further, TABLE 2 as follows indicates the graphitization temperature, the Bragg angle, and a crystallite size t (nm) obtained based on the Scherrer equation (II), as indicated below, of each of the graphitized carbon, the carbon powder No. 1 (graphitized carbon black (TOKA Black)), the carbon powder No. 2 (acetylene black) and the carbon powder No. 3 (Ketjen black).

t=(K×λ)/(B×cos θ_{B}) (II)

(in the equation, “t” represents the crystallite size (nm), “K” represents a constant (in the case of graphitized carbon, “K” is 0.9), “λ” represents a wavelength of 0.154 nm, and “θ_{B}” represents the Bragg angle).

TABLE 1

| | | | Interplanar Spacing | |
|---|---|---|---|---|
| | Graphitization | Bragg | “d” (nm) | |
| Sample (Carbon | Temperature | angle | Measured | Literature |
| Powder) | (C. °) | (2θ_{B}) | Value | Value* |
| Graphitized Carbon | — | 26.4 | — | 0.33 |
| No. 1 (Graphitized | 2,500 | 26.03 | 0.342 | — |
| Carbon Black | | | | |
| (TOKA Black) | | | | |
| No. 2 (Acetylene | 2,000 | 25.54 | 0.348 | 0.35 |
| Black) | | | | |
| No. 3 (Ketjen Black) | 1,400 | 24.28 | 0.366 | 0.37 |

*Note that in TABLE 1, the source of the literature values of the interplanar spacing d indicated therein is “JOURNAL OF APPLIED ELECTROCHEMISTRY” (2009)39: 2173-2179.

TABLE 2

| | Graphitization | Bragg | Crystallite |
|---|---|---|---|
| Sample (Carbon | Temperature | Angle | Size “t” |
| Powder) | (C. °) | (2θ_{B}) | (nm) |
| Graphitized Carbon | — | 26.4 | — |
| No. 1 (Graphitized | 2,500 | 26.03 | 7.55 |
| Carbon Black | | | |
| (TOKA Black) | | | |
| No. 2 (Acetylene Black) | 2,000 | 25.54 | 5.65 |
| No. 3 (Ketjen Black) | 1,400 | 24.28 | 2.11 |

TABLE 3

| Sample (Carbon | R Value | Interplanar Spacing |
|---|---|---|
| Powder) No. | (I_{D}/I_{G}) | “d” (nm) |
| No. 1 (graphitized Carbon | 0.47 | 0.342 |
| black (TOKA Black) | | |
| No. 2 (Acetylene Black) | 1.04 | 0.348 |
| No. 3 (Ketjen Black) | 1.16 | 0.366 |

From the results indicated in TABLE 3, it was possible to confirm that each of the graphitized carbon black (TOKA Black) as the carbon powder No. 1 and the acetylene black as the carbon powder No. 2 was a carbon powder of which R value obtained by the Raman spectroscopy is not more than 1.10 and of which interplanar spacing d (d002) measured by the X-ray powder diffraction is in a range of 0.33 nm to 0.36 nm.

On the other hand, it was possible to confirm that Ketjen black as the carbon powder No. 3 was a carbon powder of which R value obtained by the Raman spectroscopy do not satisfy the value of not more than 1.10 and of which interplanar spacing d (d002) measured by the X-ray powder diffraction did not satisfy the value in the range of 0.33 nm to 0.36 nm.

### Example

### Positive-Side Vanadium Solid Salt-Pasty Composite

TABLE 4 as follows indicates blending amounts of respective components of a positive-side pasty-vanadium solid salt composite of Example.

For the positive electrode, 0.736 g (3.13 mmol) of vanadium oxide sulfate (IV) (VOSO₄.nH₂O) was used as a compound containing vanadium ion or cation including vanadium. In the following, the compound containing vanadium ion or cation including vanadium is referred to as “vanadium compound”.

The positive-side vanadium solid salt-pasty composite was prepared in the following manner.

Firstly, Carbon powder No. 1: the graphitized carbon black (TOKA Black #3845, manufactured by TOKAI CARBON CO., LTD.) as the carbon powder was charged into a mortar made of agate, in an amount indicated in TABLE 4. Next, the vanadium oxide sulfate (IV) (VOSO₄.nH₂O) was charged in this mortar, in an amount indicated in TABLE 4. Next, the vanadium oxide sulfate (IV) (VOSO₄.nH₂O) and the graphitized carbon black were mixed and pulverized (ground) in the mortar, and thus a powdery mixture was obtained. Further, 1M sulfuric acid and 1M phosphoric acid were added to the inside of the mortar, each in an amount indicated in TABLE 4. The mixture of the vanadium oxide sulfate (IV) and the graphitized carbon black, the sulfuric acid, and the phosphoric acid were mixed and kneaded with one another inside the mortar, and thus a positive-side vanadium solid salt-pasty composite was obtained.

The molar ratio of phosphoric acid to sulfuric acid (sulfuric acid:phosphoric acid) contained in the positive-side vanadium solid salt was converted, with the mole number of the sulfuric acid indicated in TABLE 4 as “1”. The molar ratio of phosphoric acid to sulfuric acid (sulfuric acid:phosphoric acid) contained in the positive-side vanadium solid salt or in the positive-side vanadium solid salt composite was 1:1.02 (0.43:0.44).

The volume molar concentration of the sulfuric acid in the electrolyte contained in the positive-side vanadium solid salt or in the positive-side vanadium solid salt composite indicated in TABLE 4 was 0.5 mol/L.

The volume molar concentration of the phosphoric acid in the electrolyte contained in the positive-side vanadium solid salt or in the positive-side vanadium solid salt composite indicated in TABLE 4 was 0.5 mol/L.

[Negative-Side Vanadium Solid Salt-Pasty Composite]

TABLE 4 indicates blending amounts of respective components of a negative-side vanadium solid salt-pasty composite.

For the negative electrode, 0.723 g (1.57 mmol) of vanadium sulfate (III) (V₂(SO₄)₃.nH₂O) was used as a vanadium compound. The vanadium sulfate (III) was prepared in the following manner.

After dissolving vanadium sulfate in sulfuric acid, the electrolytic reduction was performed, and thus a solution of trivalent vanadium sulfate was obtained. This solution was subjected to vacuum drying at 200 degrees Celsius, and thus vanadium sulfate (III) (V₂(SO₄)₃.nH₂O) was obtained.

The negative-side vanadium solid salt-pasty composite was prepared in the following manner.

Firstly, the vanadium sulfate (III) (V₂(SO₄)₃*nH₂O) and the graphitized carbon black (TOKA Black #3845, manufactured by TOKA CARBON CO., LTD.) as the carbon powder were pulverized (ground) together in a pulverizer (a commercially available coffee mill), each in an amount indicated in TABLE 4. The pulverized vanadium sulfate (III) and the pulverized graphitized carbon black were charged into a mortar made of agate. Next, a mixed solution of 1M sulfuric acid, 1M phosphoric acid and 18M concentrated sulfuric acid were added to the inside of the mortar, each in an amount indicated in TABLE 4. The vanadium sulfate (III), the graphitized carbon black, the sulfuric acid, and the phosphoric acid were mixed and kneaded with one another inside the mortar, and thus a negative-side vanadium solid salt-pasty composite was obtained.

The molar ratio of phosphoric acid to sulfuric acid (sulfuric acid:phosphoric acid) in the electrolyte contained in the negative-side vanadium solid salt was converted, with the mole number of the sulfuric acid indicated in TABLE 4 as “1”. The molar ratio of phosphoric acid to sulfuric acid (sulfuric acid:phosphoric acid) contained in the negative-side vanadium solid salt or in the negative-side vanadium solid salt composite was 1:0.23 (0.042+0.137:0.0042).

The volume molar concentration of the sulfuric acid in the electrolyte contained in the negative-side vanadium solid salt or in the negative-side vanadium solid salt composite indicated in TABLE 4 was 1.99 mol/L.

The volume molar concentration of the phosphoric acid in the electrolyte contained in the negative-side vanadium solid salt or in the negative-side vanadium solid salt composite indicated in TABLE 4 was 0.46 mol/L.

TABLE 4

| | Positive Electrode | | | Negative Electrode | | |
|---|---|---|---|---|---|---|
| | | | % by | | | % by |
| | g | mmol | mass | g | mmol | mass |
| Vanadium | 0.736 | 3.13 | 81.9 | 0.723 | 1.57 | 80.3 |
| compound | | | | | | |
| Carbon powder | 0.071 | — | 7.90 | 0.075 | — | 8.33 |
| 1M Sulfuric Acid | 0.046 | 0.043 | 5.1 | 0.044 | 0.042 | 4.89 |
| (H₂SO₄) | | | | | | |
| 1M Phosphoric | 0.046 | 0.044 | 5.1 | 0.044 | 0.042 | 4.89 |
| Acid (H₃PO₄) | | | | | | |
| 18M Concentrated | 0 | 0 | 0 | 0.014 | 0.137 | 1.56 |
| sulfuric acid (conc. | | | | | | |
| H₂SO₄) | | | | | | |
| Total | 0.899 | — | 100 | 0.900 | — | 100 |

### Comparative Example

### Positive-Side Vanadium Solid Salt-Pasty Composite

TABLE 5 as follows indicates blending amounts of respective components of a positive-side vanadium solid salt-pasty composite of Comparative Example.

As the carbon powder, Carbon Powder No. 3: Ketjen Black (Ketjen Black EC300J, manufactured by LION SPECIALTY CHEMICALS CO., LTD.; average particle diameter: 0.0395 μm) was used. As the vanadium compound, 0.807 g (3.43 mmol) of vanadium oxide sulfate (IV) (VOSO₄.nH₂O) was used. The positive-side vanadium solid salt composite of the comparative example was prepared in a similar manner as in the example, except that Ketjen Black as the carbon powder No. 3 was used and that the vanadium oxide sulfate (IV) was used.

The molar ratio of phosphoric acid to sulfuric acid (sulfuric acid:phosphoric acid) contained in the positive-side vanadium solid salt was converted, with the mole number of the sulfuric acid indicated in TABLE 5 as “1”. The molar ratio of phosphoric acid to sulfuric acid (sulfuric acid:phosphoric acid) contained in the positive-side vanadium solid salt or in the positive-side vanadium solid salt composite was 1:1.02 (0.43:0.44).

The volume molar concentration of the sulfuric acid in the electrolyte contained in the positive-side vanadium solid salt or in the positive-side vanadium solid salt composite indicated in TABLE 5 was 0.5 mol/L.

The volume molar concentration of the phosphoric acid in the electrolyte contained in the positive-side vanadium solid salt or in the positive-side vanadium solid salt composite indicated in TABLE 5 was 0.5 mol/L.

[Negative-Side Vanadium Solid Salt-Pasty Composite]

TABLE 5 as follows indicates blending amounts of respective components of a negative-side vanadium solid salt-pasty composite of Comparative Example.

As the carbon powder, Carbon Powder No. 3: Ketjen Black (Ketjen Black EC300J, manufactured by LION SPECIALTY CHEMICALS CO., LTD.; average particle diameter: 0.0395 μm) was used. As the vanadium compound, 0.792 g (1.71 mmol) of vanadium sulfate (III) (V₂(SO₄)₃.nH₂O) was used. The negative-side vanadium solid salt composite of the comparative example was prepared in a similar manner as in the example, except that Ketjen Black as the carbon powder No. 3 was used and that the vanadium sulfate (III) in the above-specified amount was used. The molar ratio of phosphoric acid to sulfuric acid (sulfuric acid:phosphoric acid) contained in the negative-side vanadium solid salt was converted, with the mole number of the sulfuric acid indicated in TABLE 5 as “1”. The molar ratio of phosphoric acid to sulfuric acid (sulfuric acid:phosphoric acid) contained in the negative-side vanadium solid salt or in the negative-side vanadium solid salt composite was 1:0.23 (0.042+0.137:0.042).

The volume molar concentration of the sulfuric acid in the electrolyte contained in the negative-side vanadium solid salt or in the negative-side vanadium solid salt composite indicated in TABLE 5 was 1.97 mol/L.

The volume molar concentration of the phosphoric acid in the electrolyte contained in the negative-side vanadium solid salt or in the negative-side vanadium solid salt composite indicated in TABLE 5 was 0.46 mol/L.

TABLE 5

| | Positive Electrode | | | Negative Electrode | | |
|---|---|---|---|---|---|---|
| | | | % by | | | % by |
| | g | mmol | mass | g | mmol | mass |
| Vanadium | 0.807 | 3.43 | 83.2 | 0.792 | 1.71 | 81.7 |
| compound | | | | | | |
| Carbon powder | 0.071 | — | 7.32 | 0.075 | — | 7.74 |
| 1M Sulfuric Acid | 0.046 | 0.043 | 4.74 | 0.044 | 0.042 | 4.54 |
| (H₂SO₄) | | | | | | |
| 1M Phosphoric | 0.046 | 0.044 | 4.74 | 0.044 | 0.042 | 4.54 |
| Acid (H₃PO₄) | | | | | | |
| 18M Concentrated | 0 | — | 0 | 0.014 | 0.137 | 1.44 |
| sulfuric acid (conc. | | | | | | |
| H₂SO₄) | | | | | | |
| Total | 0.970 | — | 100 | 0.969 | — | 100 |

The theoretical capacity of the positive electrode and the theoretical capacity of the negative electrode were calculated in the following manner. The theoretical capacity of the battery was calculated in the following manner.

Theoretical capacity of positive electrode: Mole number of active material for the positive electrode×Faraday constant(c/mol)/(60×60) (i)

(Mole concentration of vanadium (V mole number) of the positive-side vanadium solid salt composite: 3.13 mmol in Example; 3.43 mmol in Comparative Example)

Theoretical capacity of negative electrode: Mole number of active material for the negative electrode×Faraday constant(c/mol)/(60×60) (ii)

(Mole concentration of vanadium (V mole number) of the negative-side vanadium solid salt composite: 1.57 mmol in Example; 1.71 mmol in Comparative Example)

Theoretical capacity of battery: a smaller value between the theoretical capacity of the positive electrode and the theoretical capacity of the negative electrode (iii)

The theoretical capacity of the vanadium solid-salt battery of Example was 84 mAh, and the theoretical capacity of the vanadium solid-salt battery of Comparative Example was 92 mAh.

[Vanadium Solid-Salt Battery]

A vanadium solid-salt battery of Example was manufactured in the following manner.

A positive electrode 7 includes positive-side vanadium solid salt 2 and a first current collector 5. The positive-side vanadium solid salt 2 was prepared in the following manner. The cell includes a first cell plate 11a, a first lead-out electrode 9 arranged in the first cell plate 11a, and the first current collector 5 arranged on the first lead-out electrode 9. Next, a first frame 12a is placed on the first current collector 5. Further, a positive-side vanadium solid salt-pasty composite, which composes the positive-side vanadium solid salt 2, was filled into the inside of the first frame 12a, thereby forming the positive-side vanadium solid salt 2.

A negative electrode 8 includes negative-side vanadium solid salt 3 and a second current collector 6. The negative-side vanadium solid salt 3 was prepared in the following manner. The cell includes a second cell plate 11b, a second lead-out electrode 10 arranged in the second cell plate 11b, and the second current collector 6 arranged on the second lead-out electrode 10. Next, a second frame 12b was placed on the second current collector 6. Further, a negative-side vanadium solid salt-pasty composite, which composes the negative-side vanadium solid salt 3, was filled into the inside of the second frame 12b, thereby forming the negative-side vanadium solid salt 3.

The vanadium solid-salt battery 1 includes a separator 4 which is sandwiched between the positive-side vanadium solid salt 2 and the negative-side vanadium solid salt 3. In the vanadium solid-salt battery 1, peripheral portions of the first and second cell plates 11a and 11b were clamped and fixed uniformly by six screws 13.

The materials constructing the vanadium solid-salt battery 1 are as follows.

Cell plate: a circular-shaped SUS (314) plate having thickness of 3 mm and diameter of 50 mm.

Frame: a circular-shaped frame having thickness of 1 mm and diameter of 30 mm and formed with, in a central portion thereof, a hole having diameter of 20 mm

Current collector, a graphite sheet (manufactured by KANEKA CORPORATION) having thickness of 40 μm

Lead-out electrode: a copper foil having thickness of 50 μm was used.

Separator: an ion-exchange membrane “NEOCEPTA (trade name) CMX” (manufactured by ASTOM CORPORATION)

[Coulombic Efficiency]

The vanadium solid-salt batteries of Example and Comparative Example were subjected to measurement of the charging/discharge capacity, by using a charge and discharge measuring device (model name: TOSCAT-3500 (charge and discharge evaluating device), manufactured by TOYO SYSTEM CO., LTD; battery cell: under normal temperature).

### <Number of Cycles 1 and 2>

Charging condition: Constant current (CC) charging 10 mA (upper limit: 1.6V)

Discharging condition: Constant current (CC) discharging 10 mA (lower limit: 0.8V)

### <Number of Cycle 3>

Charging condition: Constant current (CC) charging 10 mA (upper limit: 1.65V)

Discharging condition: Constant current (CC) discharging 10 mA (lower limit: 0.8V)

### <Number of Cycle 4>

Charging condition: Constant current (CC) charging 10 mA (upper limit: 1.7V)

Discharging condition: Constant current (CC) discharging 10 mA (lower limit: 0.8V)

Regarding the vanadium solid-salt battery, at first, the charging was started at the current constant (10 mA) and the charging was completed (cutoff) at a point of time when the voltage reached the upper limit value. Afterwards, regarding the vanadium solid-salt battery, the discharging was started at the constant current (10 mA), and the discharging was completed (cutoff) at a point of time when the voltage reached 0.8 V.

The coulombic efficiency of the vanadium solid-salt battery was calculated from the values of the charging/discharging capacities (mAh) in the respective cycles, based on the following formula.

Coulombic efficiency (%)=the discharging capacity (mAh) at each of the cycles/the charging capacity (mAh) at each of the cycles×100

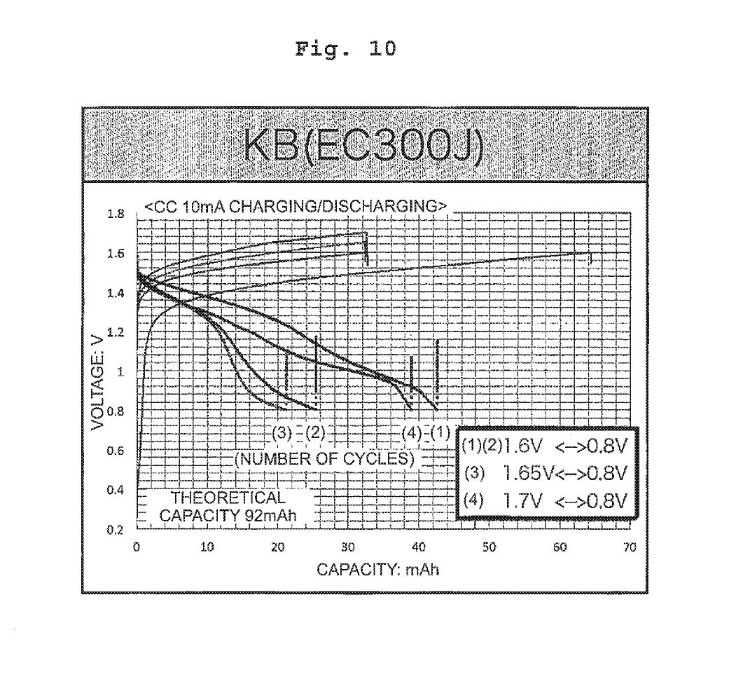

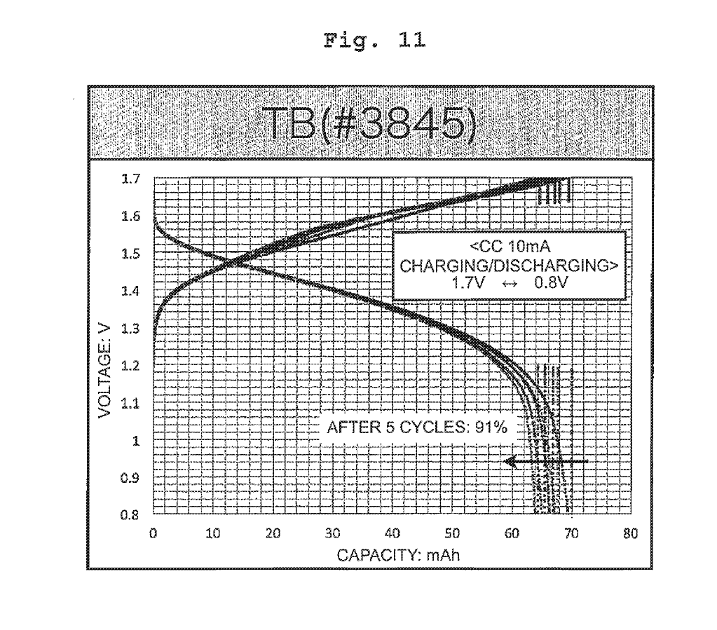

FIG. 9 depicts the charging/discharging capacity (relationship between capacity (mAh) and voltage (V)) of the vanadium solid-salt battery of Example, at each of the number of cycles 1 to 4. FIG. 10 depicts the charging/discharging capacity (relationship between capacity (mAh) and voltage (V)) of the vanadium solid-salt battery of Comparative Example, at each of the number of cycles 1 to 4. Further, TABLE 6 as follows indicates the discharging capacity (mAh), the charging capacity (mAh), and the coulombic efficiency (%) calculated from the discharging capacity (mAh) and the charging capacity (mAh) at each of the cycles in Example. TABLE 7 as follows indicates the discharging capacity (mAh), the charging capacity (mAh), and the coulombic efficiency (%) calculated from the discharging capacity (mAh) and the charging capacity (mAh) at each of the cycles in Comparative Example.

TABLE 6
EXAMPLE

| No. of | Charging | Discharging | Coulombic |
|---|---|---|---|
| cycles | capacity (mAh) | capacity (mAh) | efficiency (%) |
| 1 | 43.9 | 39.7 | 90.6 |
| 2 | 43.9 | 43.4 | 98.8 |
| 3 | 60.9 | 59.9 | 98.4 |
| 4 | 72.2 | 70.9 | 98.3 |

TABLE 7
COMPARATIVE EXAMPLE

| No. of | Charging | Discharging | Coulombic |
|---|---|---|---|
| cycles | capacity (mAh) | capacity (mAh) | efficiency (%) |
| 1 | 65.6 | 42.6 | 65.0 |
| 2 | 32.7 | 25.4 | 77.7 |
| 3 | 32.4 | 21.2 | 65.4 |
| 4 | 32.5 | 39.0 | 119.8 |

From the results indicated in FIG. 9 and TABLE 6, it is appreciated that the PP-3, vanadium solid-salt battery of Example (using the graphitized carbon black) was capable of obtaining the coulombic efficiency that is approximately 100% even when the charging cutoff voltage was raised up to 1.7 V (number of cycle 4). On the other hand, from the results indicated in FIG. 10 and TABLE 7, it is appreciated that the vanadium solid-salt battery of Comparative Example (using Ketjen black) had a low coulombic efficiency. Further, regarding the vanadium solid-salt battery of Comparative Example (using Ketjen black), it was observed that the capacity was degraded up to the charging cutoff voltage, 1.6V and 1.65V as the number of cycles was increased. In the vanadium solid-salt battery of Comparative Example (using Ketjen black), however, when the battery was charged up to the charging cutoff voltage 1.7V (number of cycle 4), the discharging capacity was suddenly raised, and the coulombic efficiency exceeded 100%.

[Capacity Maintenance Rate]

The vanadium solid-salt batteries of Example and Comparative Example were subjected to measurement of initial discharging capacity, by using a charge and discharge measuring device (model name: TOSCAT-3500 (charge and discharge evaluating device), manufactured by TOYO SYSTEM CO., LTD.; battery cell: under normal temperature). Next, the vanadium solid-salt batteries of Example and Comparative Example were subjected to measurement of charging/discharging repeatedly for 5 cycles under a same condition. The discharging capacity at the fifth cycle, to the initial discharging capacity 100% of the vanadium solid-salt battery, was determined to be the capacity maintenance rate of the vanadium solid-salt battery.

Charging condition: Constant current (CC) charging 10 mA (upper limit: 1.7V)

Discharging condition: Constant current (CC) discharging 10 mA (lower limit: 0.8V)

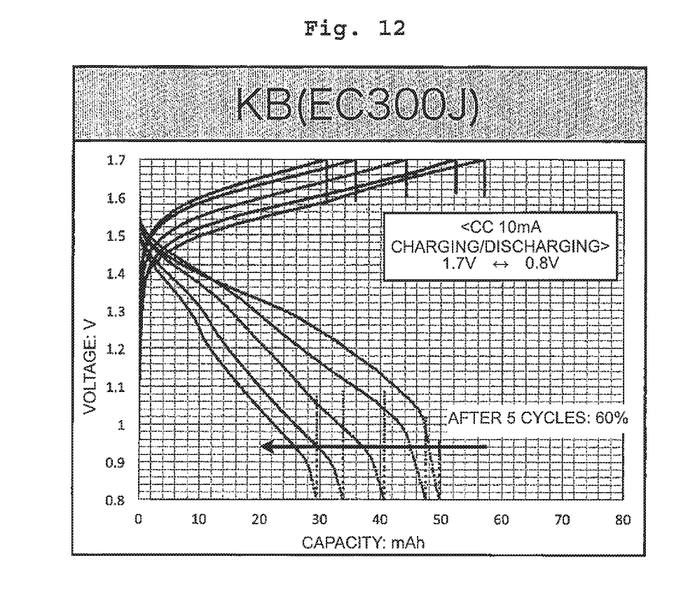

FIG. 11 depicts the charging/discharging capacity (relationship between capacity (mAh) and voltage (V)) of the vanadium solid-salt battery of Example, from the initial discharging capacity up to the discharging capacity at the fifth cycle. The capacity maintenance rate of the vanadium solid-salt battery of Example after the 5 cycles was 91%.

FIG. 12 depicts the charging/discharging capacity (relationship between capacity (mAh) and voltage (V)) of vanadium solid-salt battery of Comparative Example, from the initial discharging capacity up to the discharging capacity at the fifth cycle. The capacity maintenance rate of the vanadium solid-salt battery of Comparative Example after the 5 cycles was 60%.

[Energy Efficiency (%)]

The vanadium solid-salt batteries of Example and Comparative Example were subjected to measurement of charging/discharging electric power (mWh), by using a charge and discharge measuring device (model name: TOSCAT-3500 (charge and discharge evaluating device), manufactured by TOYO SYSTEM CO., LTD.; battery cell: under normal temperature), under a same condition as that for measuring the coulombic efficiency. The energy efficiency of the vanadium solid-salt battery was calculated from the values of the charging/discharging electric power (mWh) in the respective cycles, based on the following formula.

Energy efficiency (%)=the discharging electric power (mWh) at each of the cycles/the charging electric power (mWh) at each of the cycles×100

TABLE 8 as follows indicates the charging electric power (mWh), the discharging electric power (mWh), and the energy efficiency (%) calculated from the charging electric power (mWh) and the discharging electric power (mWh) at each of the cycles in Example. TABLE 9 as follows indicates the charging electric power (mWh), the discharging electric power (mWh), and the energy efficiency (%) calculated from the charging electric power (mWh) and the discharging electric power (mWh) at each of the cycles in Comparative Example.

TABLE 8
EXAMPLE

| No. of | Charging electric | Discharging electric | Energy |
|---|---|---|---|
| cycles | power (mWh) | power (mWh) | efficiency (%) |
| 1 | 65.3 | 49.7 | 76.2 |
| 2 | 66.6 | 54.3 | 81.5 |
| 3 | 94.0 | 77.2 | 82.1 |
| 4 | 112.4 | 93.9 | 83.5 |

TABLE 9
COMPARATIVE EXAMPLE

| No. of | Charging electric | Discharging electric | Energy |
|---|---|---|---|
| cycles | power (mWh) | power (mWh) | efficiency (%) |
| 1 | 94.8 | 50.8 | 53.6 |
| 2 | 49.9 | 28.9 | 58.0 |
| 3 | 50.7 | 24.5 | 48.3 |
| 4 | 52.4 | 44.8 | 85.5 |

As indicated in FIG. 11, the capacity maintenance rate of the vanadium solid-salt battery of Example after the 5 cycles was 91%. In contrast, as indicated in FIG. 12, the capacity maintenance rate of the vanadium solid-salt battery of Comparative Example after the 5 cycles was 60%. From these results, it is appreciated that the vanadium solid-salt battery of the present disclosure had an improved capacity maintenance rate.

From the results indicated in TABLE 8, it is appreciated that the vanadium solid-salt battery of Example (using the graphitized carbon black) had the energy efficiency exceeding 75% even when the battery was charged up to the cutoff voltage 1.6 V (number of cycles 1 and 2), up to 1.65 V (number of cycle 3), and up to 1.7 V (number of cycle 4), thus maintaining a high energy efficiency. On the other hand, from the results indicated in TABLE 9, it is appreciated that the vanadium solid-salt battery of Comparative Example (using Ketjen black) had the energy efficiency less than 60% when the battery was charged up to the cutoff voltage 1.6 V (number of cycles 1 and 2) and up to 1.65 V (number of cycle 3).

The vanadium solid-salt battery of Example (using the graphitized carbon black) is considered as capable of withstanding charging/discharging at a high voltage as compared with that of Comparative Example, owing to the difference in the degree of graphitization due to the graphitization processing temperature between the graphitized carbon black (Example) and Ketjen black (Comparative Example). Since the graphitized carbon black has a higher degree of graphitization (higher degree of crystallinity) than that of Ketjen black, the overvoltage in electrolysis of water is increased.

In the present disclosure, since the vanadium solid salt is allowed to contain the specified amount of carbon powder of which R value obtained by the Raman spectroscopy is the specified value and of which interplanar distance d measured by the X-ray powder diffraction is the specified value, it is possible to maintain the balance of the redox state of the vanadium ion or the cation including vanadium in the positive and negative electrodes. The present disclosure is capable of maintaining the balance of the redox state of the vanadium ion or the cation including vanadium in the positive and negative electrodes, thereby making it possible to improve the capacity maintenance rate, coulombic efficiency and energy efficiency of the vanadium solid-salt battery. The vanadium solid-salt battery is widely usable not only in the field of large electric power storage, but also in personal computers, personal digital assistants (PDAs), digital cameras, digital media players, digital recorders, game devices, electrical appliances, vehicles, radio equipment, cellphones, etc., and is industrially useful.

What is claimed is:

1. A vanadium solid-salt battery comprising:
a positive electrode and a negative electrode each of which includes vanadium solid salt, the vanadium solid salt containing an electrolyte, a carbon material, and vanadium ion and/or cation including vanadium,
wherein the carbon material is carbon powder of which R value obtained by Raman spectroscopy is not more than 1.10 or of which interplanar spacing d (d002) measured by X-ray powder diffraction is in a range of 0.33 nm to 0.36 nm; and
a content amount of the carbon material in the vanadium solid salt is in a range of 1% by mass to 42% by mass.

2. The vanadium solid-salt battery according to claim 1, wherein the electrolyte contains sulfuric acid;
volume molar concentration of the sulfuric acid in the electrolyte contained in the vanadium solid salt for the positive electrode is in a range of 0.34 mol/L to 0.80 mol/L; and
volume molar concentration of the sulfuric acid in the electrolyte contained in the vanadium solid salt for the negative electrode is in a range of 1.83 mol/L to 2.24 mol/L.

3. The vanadium solid-salt battery according to claim 1, wherein the electrolyte contains phosphoric acid or phosphate;
volume molar concentration of the phosphoric acid or phosphate in the electrolyte contained in the vanadium solid salt for the positive electrode is in a range of 0.20 mol/L to 0.66 mol/L; and
volume molar concentration of the phosphoric acid or phosphate in the electrolyte contained in the vanadium solid salt for the negative electrode is in a range of 0.18 mol/L to 0.60 mol/L.

4. The vanadium solid-salt battery according to claim 1, wherein the electrolyte contains sulfuric acid, and phosphoric acid or phosphate;
molar ratio of the phosphoric acid or phosphate to the sulfuric acid in the electrolyte contained in the vanadium solid salt for the positive electrode is in a range of (phosphoric acid or phosphate)/(sulfuric acid)=0.25 to 1.94; and
molar ratio of the phosphoric acid or phosphate to the sulfuric acid in the electrolyte contained in the vanadium solid salt for the negative electrode is in a range of (phosphoric acid or phosphate)/(sulfuric acid)=0.082 to 0.333.

5. The vanadium solid-salt battery according to claim 1, wherein at least one of the vanadium solid salt for the positive electrode and the vanadium solid salt for the negative electrode further contains a binder.

6. A vanadium solid salt composite for forming vanadium solid salt for positive electrode of a vanadium solid-salt battery, the vanadium solid salt composite for positive electrode comprising:
vanadium oxide sulfate (IV);
an electrolyte; and
a carbon powder of which R value obtained by Raman spectroscopy is not more than 1.10 and of which interplanar spacing d (d002) measured by X-ray powder diffraction is in a range of 0.33 nm to 0.36 nm,
wherein a content amount of the vanadium oxide sulfate (IV) in the vanadium solid salt composite is in a range of 57.0% by mass to 85.0% by mass.

7. A vanadium solid salt composite for forming vanadium solid salt for negative electrode of a vanadium solid-salt battery, the vanadium solid salt composite for negative electrode comprising:
vanadium sulfate (III);
an electrolyte; and
a carbon powder of which R value obtained by Raman spectroscopy is not more than 1.10 and of which interplanar spacing d (d002) measured by X-ray powder diffraction is in a range of 0.33 nm to 0.36 nm,
wherein a content amount of the vanadium sulfate (III) in the vanadium solid salt composite is in a range of 56.0% by mass to 83.0% by mass.
